(19) United States
(12) Patent Application Publication
(10) Pub. No.: US 2017/0046266 A1
(43) Pub. Date: Feb. 16, 2017

(54) Way Mispredict Mitigation on a Way Predicted Cache

(71) Applicant: QUALCOMM Incorporated, San Diego, CA (US)

(72) Inventors: Michael Scott McIlvaine, Raleigh, NC (US); Gaurav Mehta, Morrisville, NC (US); Robert Douglas Clancy, Cary, NC (US)

(21) Appl. No.: 15/084,773

(22) Filed: Mar. 30, 2016

Related U.S. Application Data
(60) Provisional application No. 62/205,626, filed on Aug. 14, 2015.

(51) Int. Cl. G06F 12/08

(52) U.S. Cl. CPC G06F 12/0862; G06F 12/0864; G06F 12/0891; G06F 2212/1021; G06F 2212/602; G06F 2212/1028

(57) ABSTRACT

Described herein are apparatuses, methods, and computer readable media for way mispredict mitigation on a way predicted set-associative cache. A way prediction array may be accessed while searching the cache for data. A predicted way to search for the data may be determined from the way prediction array. If the search for the data in the predicted way results in a miss, a first prediction index associated with a cache line in the predicted way may be determined. The first prediction index may be compared to a second prediction index. The second prediction index may be associated with a search address being used for accessing the cache during execution of an instruction. If there is a match, the predicted way may be selected as a victim way.

### CROSS-REFERENCE TO RELATED APPLICATIONS

The present application claims priority to U.S. Provisional Application No. 62/205,626, filed Aug. 14, 2015, titled “Way Mispredict Mitigation On A Way-Predicted Cache,” the entirety of which is incorporated herein by reference.

### TECHNICAL FIELD

The present application generally relates to a cache memory system.

### BACKGROUND

Accessing a cache of a processor consumes a significant amount of power. A set in the cache includes one or more cache lines (e.g., storage locations). The cache includes an instruction array having multiple sets that each include one or more cache lines. A way of a cache includes a driver corresponding to at least one cache line (e.g., a cache block) of the cache. In response to an instruction to access data stored in the cache, all of the drivers are enabled (e.g., activated) to drive, via a plurality of data lines, the ways of a particular set of the instruction array to a multiplexer.

In parallel (e.g., concurrently) with all of the drivers being enabled, a lookup operation is performed to identify a particular cache line within the instruction array. Based on a result of the lookup operation, data provided via a single driver corresponding to a single cache line is selected as an output. Driving all of the ways for a set and performing the lookup operation causes power to be expended and results in a power inefficiency, considering that data from only a single cache line will be output based on the instruction. Accesses to the cache are frequently predictable, and prediction methods utilizing predictable sequences of instructions may be used to identify a particular way of the cache to be driven. If a prediction method is applied to a cache, a performance penalty (e.g., a delay in processing) and an energy penalty may result from each misprediction (e.g., making an incorrect prediction) of a way to be accessed. Therefore, there is a need to lower the occurrences of misprediction.

### SUMMARY

Described herein are various aspects of way mispredict mitigation on a way predicted set-associative cache. In some aspects, a method is provided for way mispredict mitigation on a way predicted set-associative cache. In some aspects, the method comprises searching the cache for data. In some aspects, the data is associated with a first cache line. In some aspects, the method further comprises accessing, while searching the cache, a way prediction array comprising entries associated with ways of the cache. In some aspects, the method further comprises determining, from the way prediction array, based on a prediction technique, a predicted way to search for the data. In some aspects, the method further comprises searching the predicted way to determine a hit or a miss for the data. In some aspects, the method further comprises determining the miss in the predicted way for the data. In some aspects, in response to determining the miss in the predicted way for the data, the method further comprises: determining a first prediction index associated with a second cache line comprised in the predicted way, determining a second prediction index associated with a search address, the search address being used for accessing the cache during execution of an instruction, determining whether the first prediction index matches the second prediction index, and in response to determining the first prediction index matches the second prediction index, selecting the predicted way as a victim way.

The aspects presented herein reduce or eliminate the chance of way prediction array entries in multiple ways of a cache having the same prediction index, which reduces or eliminates the chance of mispredicting the multiple ways of the cache.

In some aspects, the method further comprises writing the data associated with the first cache line to the victim way. In some aspects, the set-associative cache comprises a multiple way set-associative cache. In some aspects, the method further comprises reading the way prediction array for determining the predicted way to search for the data. In some aspects, the second prediction index is associated with the first cache line being searched for in the cache. In some aspects, the method further comprises in response to determining the first prediction index matches the second prediction index, overriding a victim selection policy used for selecting the victim way. In some aspects, the method further comprises in response to determining the first prediction index does not match the second prediction index, using a victim selection policy for selecting the victim way.

In some aspects, an apparatus is provided for way mispredict mitigation on a way predicted set-associative cache. The apparatus comprises a memory storing instructions, control logic comprising a way prediction array, and a processor comprising the cache and coupled to the control logic and the memory. The processor is configured to search the cache for data. In some aspects, the data is associated with a first cache line. The processor is further configured to access, while searching the cache, a way prediction array comprising entries associated with ways of the cache. The processor is further configured to determine, from the way prediction array and based on a prediction technique, a predicted way to search for the data. The processor is further configured to determine a miss in the predicted way for the data. In response to the processor determining the miss in the predicted way for the data, the processor is further configured to: determine a first prediction index associated with a second cache line comprised in the predicted way, determine a second prediction index associated with a search address, the search address being used for accessing the cache during execution of the instruction, determine whether the first prediction index matches the second prediction index, and in response to determining the first prediction index matches the second prediction index, select the predicted way as a victim way.

In some aspects, the processor is further configured to write the data associated with the first cache line to the victim way. In some aspects, the processor is further configured to read the way prediction array for determining the predicted way to search for the data. In some aspects, the processor is further configured to in response to determining the first prediction index matches the second prediction index, override a victim selection policy used for selecting the victim way. In some aspects, the processor is further configured to in response to determining the first prediction index does not match the second prediction index, use a victim selection policy for selecting the victim way.

In some aspects, another apparatus is provided for way mispredict mitigation on a way predicted set-associative cache. In some aspects, the apparatus comprises means for searching the cache for data. In some aspects, the data is associated with a first cache line. In some aspects, the apparatus further comprises means for accessing, while searching the cache, a way prediction array comprising entries associated with ways of the cache. In some aspects, the apparatus further comprises means for determining, from the way prediction array, based on a prediction technique, a predicted way to search for the data. In some aspects, the apparatus further comprises means for searching the predicted way to determine a hit or a miss for the data. In some aspects, the apparatus further comprises means for determining the miss in the predicted way for the data. In some aspects, in response to determining the miss in the predicted way for the data, the apparatus further comprises: means for determining a first prediction index associated with a second cache line comprised in the predicted way, means for determining a second prediction index associated with a search address, the search address being used for accessing the cache during execution of an instruction, means for determining whether the first prediction index matches the second prediction index, and in response to determining the first prediction index matches the second prediction index, means for selecting the predicted way as a victim way.

In some aspects, the apparatus further comprises means for writing the data associated with the first cache line to the victim way. In some aspects, the apparatus further comprises means for reading the way prediction array for determining the predicted way to search for the data. In some aspects, the apparatus further comprises in response to determining the first prediction index matches the second prediction index, means for overriding a victim selection policy used for selecting the victim way. In some aspects, the apparatus further comprises in response to determining the first prediction index does not match the second prediction index, means for using a victim selection policy for selecting the victim way. In some aspects, a non-transitory computer readable medium is provided comprising computer executable code configured to perform the various methods described herein.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 illustrates elements of a processor system that reads from a way prediction array, in accordance with some aspects of this disclosure;

FIG. 2 illustrates elements of a processor system that writes to a way prediction array, in accordance with some aspects of this disclosure;

FIG. 3 illustrates a method for way mispredict mitigation, in accordance with some aspects of this disclosure; and

FIG. 4 illustrates a block diagram of a computing device including a cache and logic to perform way mispredict mitigation, in accordance with some aspects of this disclosure.

Although similar reference numbers may be used to refer to similar elements for convenience, each of the various example aspects may be considered distinct variations.

### DETAILED DESCRIPTION

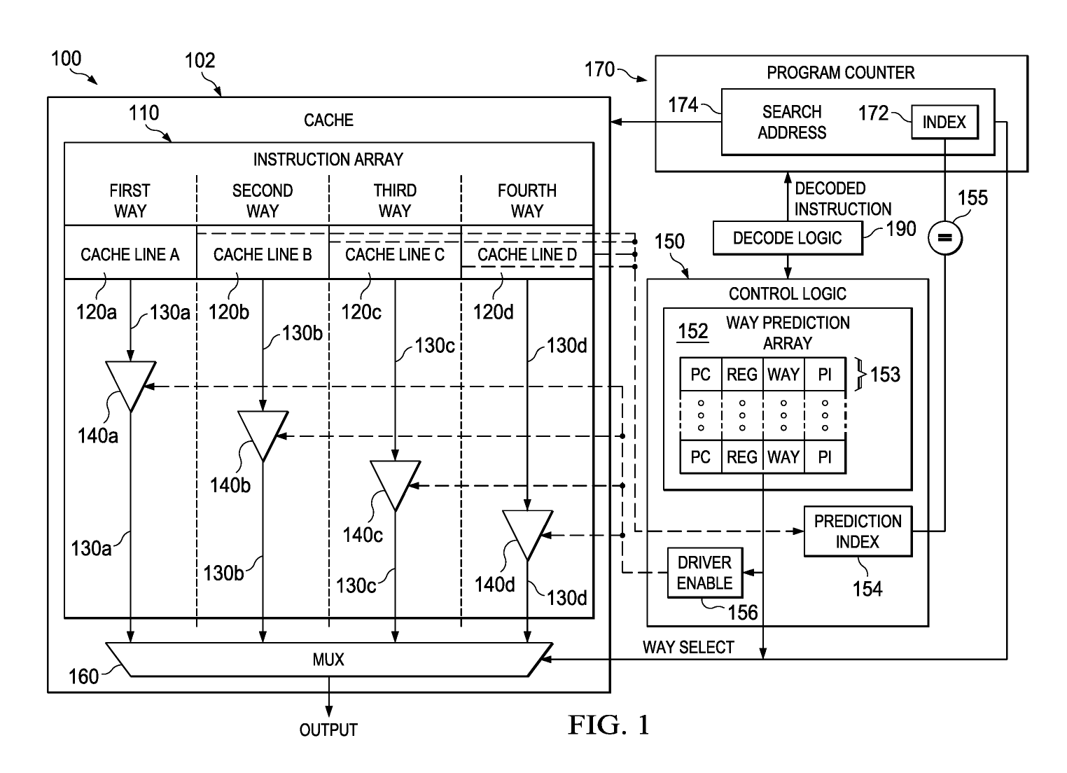

FIG. 1 illustrates elements of a processor system 100 that utilizes a way prediction array 152. The processor system 100 includes a cache 102, control logic 150, a program counter 170, and decode logic 190. The cache 102 includes an instruction array 110 that includes a plurality of cache lines 120a-d. In a particular aspect, the cache 102 comprises a set-associative cache. In some aspects, the cache 102 may be an instruction cache or a data cache. A cache way (or just “way”) and/or a cache line (or just “line”) may be associated with the cache 102.

The processor system 100 is configured to execute (e.g., process) instructions (e.g., a series of instructions) included in a program. The program may include a loop, or multiple loops, in which a series of instructions are executed one or more times. When the instructions are executed as part of a loop (e.g., executed several times), the instructions may each include a predictable access pattern that indicates that an effective address retrieved, based on the next execution of the instruction, will be available from a same cache line 120a-d (e.g., a same way) of the instruction array 110. The predictability of the access pattern allows more efficient access to addresses, which in turn leads to more efficient memory access systems and methods.

Accordingly, during execution of the instructions (e.g., during one or more iterations of the loop), a particular way of the cache 102 that is accessed for an instruction may be identified. Based on the technique that a cache line comprising instructions is written into the cache, it is possible to predict the location (way) of that cache line in the set, when the cache is subsequently searched for that cache line. Accordingly, the processor system 100 may generate, maintain, and use a way prediction array 152, as described below, to predict way accesses for one or more instructions.

The cache 102 may include the instruction array 110 and a multiplexer 160. The cache 102 may be configured to store (in a cache line) recently or frequently used data. Data stored in the cache 102 may be accessed more quickly than data accessed from another location, such as a main memory (not shown). In a particular aspect, the cache 102 is a set-associative cache, such as a four-way set-associative cache. Additionally or alternatively, the cache 102 may include the control logic 150, the program counter 170, the decode logic 190, or a combination thereof.

The instruction array 110 may be accessed during execution of the instruction (executed by the processor system 100). The instruction may be included in a program (e.g., a series of instructions) and may or may not be included in a loop (e.g., a software loop) of the program. The instruction array 110 includes a plurality of sets (e.g., rows) that each include a plurality of ways (e.g., columns), such as a first way, a second way, a third way, and a fourth way as depicted in FIG. 1. Each of the ways may be associated with a cache line (e.g., a single cache line, multiple cache lines, etc.) within a column of the cache 102 and associated with a corresponding cache line 120a-d (e.g., a single cache line) of each set of the cache 102. The plurality of ways may be accessed during execution of the program. Each way of the plurality of ways may include a driver 140a-d (e.g., a line driver) and a data line 130a-d that corresponds to multiple cache lines (e.g., storage locations) within a column of the instruction array 110. For example, the first way may be associated with a cache line A 120a and includes a first driver 140a and a first data line 130a, the second way may be associated with a cache line B 120b and includes a second driver 140b and a second data line 130b, the third way may be associated with a cache line C 120c and includes a third driver 140c and a third data line 130c, and the fourth way may be associated with a cache line D 120d and includes a fourth driver 140d and a fourth data line 130d.

Each driver 140a-d may enable data stored in a corresponding cache line 120a-d (e.g., a corresponding cache block) to be read (e.g., driven) from the instruction array 110 via a corresponding data line 130a-d and provided to the multiplexer 160. The content stored in a particular cache line of the cache lines 120a-d may include multiple bytes (e.g., thirty-two (32) bytes or sixty-four (64) bytes). In a particular aspect, the particular cache line may correspond to a block of sequentially addressed memory locations. For example, the particular cache line may correspond to a block of eight sequentially addressed memory locations (e.g., eight 4-byte segments).

The decode logic 190 may receive one or more instructions (e.g., a series of instructions) to be executed by the processor system 100. The decode logic 190 may include a decoder configured to decode a particular instruction of the one or more instructions and to provide the decoded instruction (including an index 172 comprised in or associated with a search address 174) to the program counter 170. The decode logic 190 may also be configured to provide instruction data associated with the particular instruction to the control logic 150, such as by sending data or modifying one or more control registers.

The program counter 170 may identify an instruction to be executed based on the decoded instruction received from the decode logic 190. The program counter 170 may include the index 172 and the search address 174 comprising the index 172, both which may be used to access the cache 102 during an execution of the instruction. Each time an instruction is executed, the program counter 170 may be adjusted (e.g., incremented) to identify a next instruction to be executed. In some aspects, incrementing the program counter 170 may comprise incrementing the index 172.

The control logic 150 may include the way prediction array 152 and a driver enable circuit 156. The control logic 150 may be configured to receive instruction data (e.g., instruction data that corresponds to an instruction to be executed) from the decode logic 190 and access the way prediction array 152 based on at least a portion of the instruction data. In some aspects, the cache 102, the program counter 170, the decode logic 190, and the control logic 150 may be connected to a memory (not shown in FIG. 1). The memory may comprise a program that includes a series of instructions for execution by the processor system 100.

The way prediction array 152 may include one or more entries 153 that each includes one or more fields. Each entry 153 may correspond to a different instruction and include a program counter (PC) field, a register location identifier (REG) field, a predicted way (WAY) field, a prediction index field (PI), or a combination thereof. For a particular entry, the PC field may identify a corresponding instruction executed, by the processor system 100. The WAY field (e.g., a predicted way field) may include a value (e.g., a way field identifier) that identifies a way (of the instruction array 110) that was previously accessed (e.g., a “last way” accessed) the last time the corresponding instruction was executed. In other aspects, the WAY field may include a predicted way based on a computation that results in a predicted way that was not the previously accessed way the last time the corresponding instruction was executed. The REG field may identify a register location of a register file (not shown) that was modified the last time the corresponding instruction was executed. The PI field may identify a prediction index associated with an entry. The PI serves as the index to the way prediction array 152 (e.g., the index for reading the way prediction array 152). The way prediction array 152 may be maintained (e.g., stored) at a processor core of the processor system 100 and/or may be included in or associated with a prefetch table of the cache 102.

The control logic 150 may be configured to access the instruction data (e.g., instruction data that corresponds to an instruction to be executed) provided by the decode logic 190. Based on at least a portion of the instruction data, the control logic 150 may determine whether the way prediction array 152 includes an entry that corresponds to the instruction. If the way prediction array 152 includes an entry that corresponds to the instruction, the control logic 150 may use the way prediction array 152 to predict a way for an instruction to be executed. The control logic 150 may selectively read the way prediction array 152 to identify the entry 153 of the way prediction array 152 that corresponds to the instruction based on the PC and/or PI field of each entry 153. When the control logic 150 identifies the corresponding entry 153, the control logic 150 may use the value of the WAY field for the entry 153 as the way prediction by providing (or making available) the value of the WAY field to the driver enable circuit 156.

The driver enable circuit 156 may be configured to selectively activate (e.g., turn on) or deactivate (e.g., turn off) one or more of the drivers 140a-d based on the predicted way identified in the way prediction array 152. By maintaining the way prediction array 152 for instructions executed by the processor system 100, one or more drivers 140a-d of the instruction array 110 of the cache 102 may be selectively disabled (e.g., drivers associated with unselected ways) based on the predicted way and a power benefit may be realized during a data access of the cache 102.

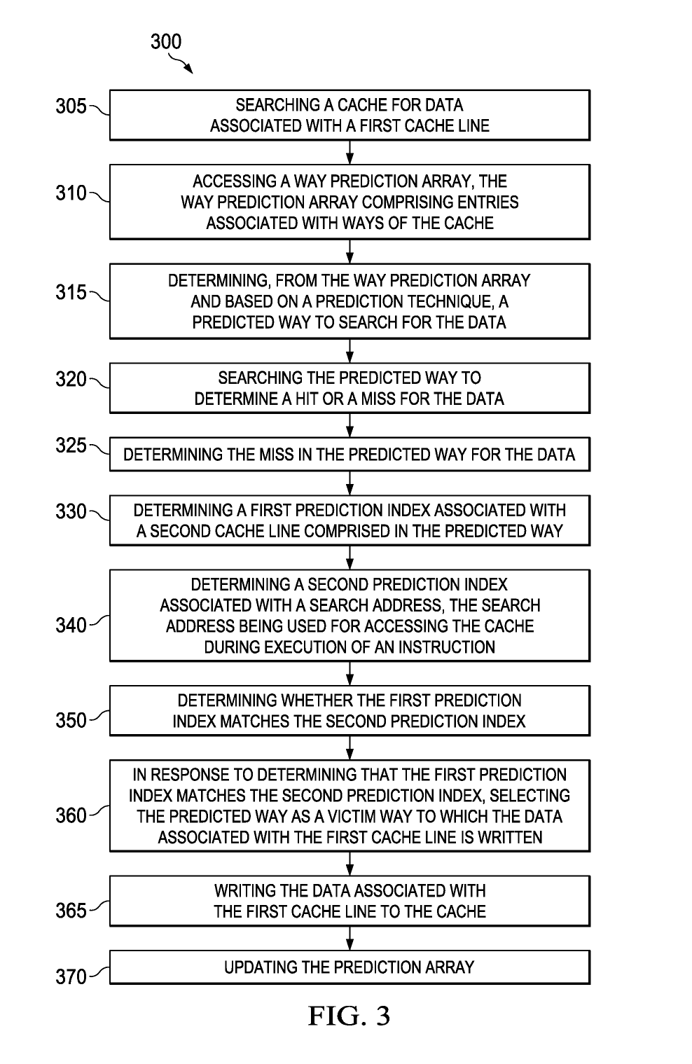

The prediction index 154 of the predicted way may be read by the processor system 100. A comparator 155 may be used to compare the prediction index 154 associated with the predicted way to the index 172. As described in FIG. 3, if a match is found between the prediction index 154 and the index 172, the predicted way may be used as the victim way. As used herein, a victim way is the way to which data associated with a cache line is written. Therefore, if a match is found, a victim way selection policy used for selecting the victim way is overridden. If a match is not found, the victim way selection policy is used for selecting the victim way.

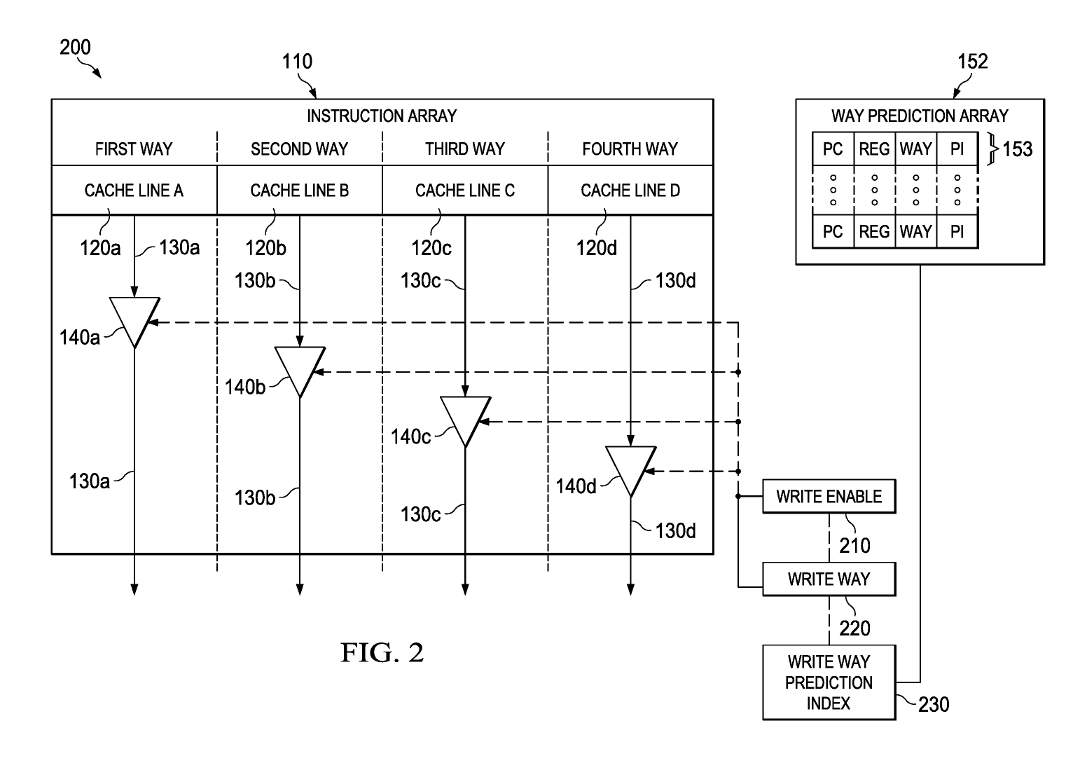

FIG. 2 illustrates elements of a processor system 200 that writes to a way prediction array 152. The instruction array 110 of FIG. 1 is also presented in FIG. 2. Although not shown, the instruction array 110 resides in the cache 102 of FIG. 1. The write enable block 210 enables a way selected for a write operation to be written to the way prediction array 152. The way selected for the write operation is based on a victim selection policy if the index 172 does not match prediction index 154. Alternatively, the way selected for the write operation is the predicted way if the index 172 matches the prediction index 154. The write way block 220 enables a predicted way from the instruction array 102 to be written to the way prediction array 152. The write way prediction index block 250 enables a predicted way associated with a prediction index to be written to the way prediction array 152.

FIG. 3 illustrates a way misprediction mitigation method for a cache based on an n-entry way prediction array for each set in the cache. As described previously, a way prediction array may be indexed during a search operation by a prediction index. The number of search address bits required to access the way prediction array is log 2(n) for an n-entry way prediction array.

At block 305, the method comprises searching a cache for data associated with a first cache line. In some aspects, the data may comprise the first cache line. At block 310, the method comprises accessing, while searching the cache, the way prediction array. The term “while” may refer to either “after” or “during.” The way prediction array may comprise entries associated with ways of the cache. Each entry may be associated with a predicted way and a prediction index. Way prediction array entry values (e.g., a predicted way, a prediction index, etc.) for a given set in the cache may be written to the way prediction array entry when a write is performed to that set. The value(s) written to the way prediction array entry may be associated with the way being written currently. In some aspects, this means that a given way prediction array entry is associated with the last way that was written using the prediction index associated with that entry. It is desirable to not have entries corresponding to the same prediction index in multiple ways of the n-way set-associative cache since the shared prediction index of the multiple ways means that those multiple ways correspond to a single entry in the prediction array. This means that only one way of those multiple ways, the one which is associated with the prediction array entry, is predicted correctly. The rest of the ways are mispredicted. The method presented herein defines a way to reduce or eliminate the chance of way prediction array entries in multiple ways having the same prediction index.

At block 315, the method comprises determining, from the way prediction array and based on a prediction technique, a predicted way to search for the data. In some aspects, the method, at block 315, further comprises reading the way prediction array for determining the predicted way to search for the data. In some aspects, the predicted way may be a last way that written to an entry of the way prediction array. At block 320, the method comprises searching the predicted way to determine a hit or a miss for the data. The predicted way may comprise a cache line, which may also be referred to as the second cache line. At block 325, the method comprises determining a miss in the predicted way for the data.

Blocks 330 to 370 may be performed in response to determining a miss at block 325. At block 330, the method comprises determining or reading a first prediction index associated with the second cache line comprised in the predicted way. The first prediction index may be associated with a second cache line that is in the predicted way during the search related to the first cache line in block 305.

At block 340, the method comprises determining or reading, from a search address, a second prediction index associated with the search address. The search address is used for accessing the cache during execution of an instruction. The second prediction index is associated with the first cache line being searched in block 305. At block 350, the method comprises determining whether the first prediction index matches the second prediction index by comparing the first prediction index to the second prediction index. If there is no match at block 350, a victim way is selected based on a victim way selection policy or a replacement policy (e.g., a least recently used (LRU) replacement policy). At block 360, the method comprises in response to determining that the first prediction index matches the second prediction index, selecting the predicted way as the victim way to which data associated with the first cache line is written. Following block 360, the method, at block 365, further comprises writing data associated with the first cache line to the cache. In response to the data associated with the first cache line being written to the cache, the method, at block 370, comprises updating the prediction array. Updating the prediction array may comprise updating a prediction array entry associated with the second prediction index with a pointer to the victim way.

The method described herein reduces the probability of multiple ways in the cache having the same prediction index. Additionally, the method requires the tracking of two bits of data: whether or not to use the victim way selection policy (based on the first prediction index matching the second prediction index) and the predicted way.

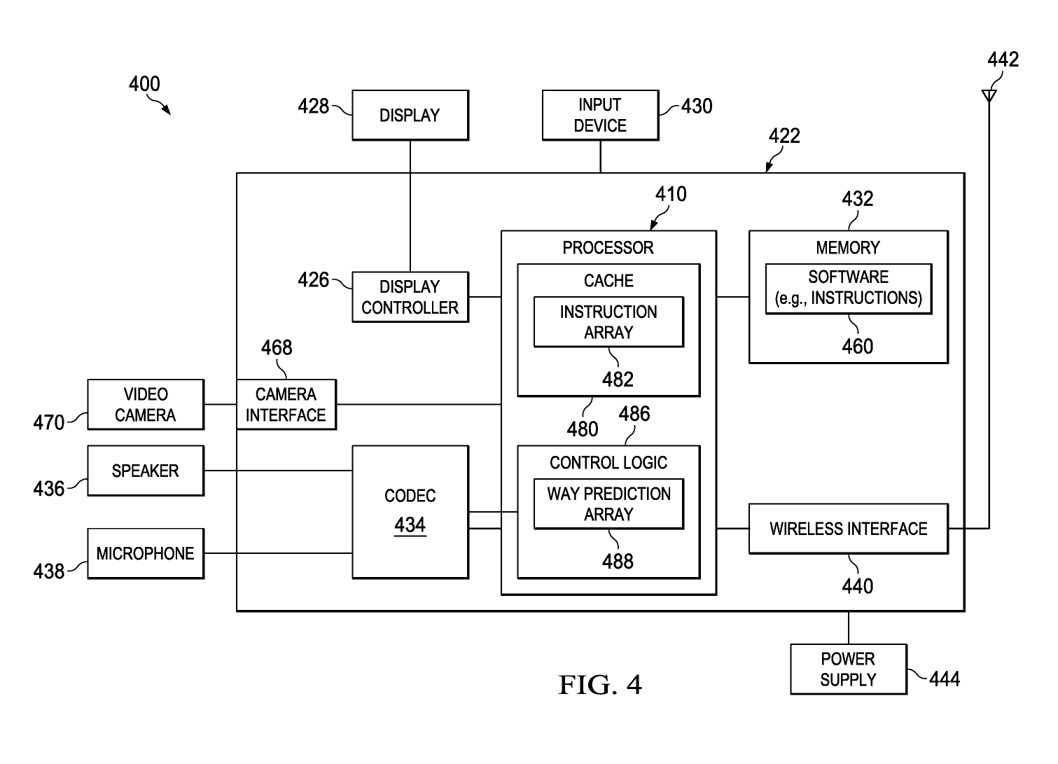

FIG. 4 is a block diagram of a device 400 including a cache memory system. The device 400 may be a computing device and may include a processor 410, such as a digital signal processor (DSP) or a central processing unit (CPU), coupled to a memory 432.

The processor 410 may be configured to execute software 460 (e.g., a program of one or more instructions) stored in the memory 432. The processor 410 may include a cache 480 and control logic 486. For example, the cache 480 may include or correspond to the cache 102 of FIG. 1, and the control logic 486 may include or correspond to the control logic 150 of FIG. 1. The cache 480 may include an instruction array 482. The instruction array 482 may correspond to the instruction array 110 of FIG. 1. The instruction array 482 may include a plurality of line drivers, such as the line drivers 140a-d of FIG. 1. The control logic 486 may include a way prediction array 488. The way prediction array 488 may include or correspond to the way prediction array 152 of FIG. 1. In an illustrative example, the processor 410 includes or corresponds to the processor system 100 of FIG. 1, or components thereof, and operates in accordance with any of the aspects of FIG. 1-4, or any combination thereof.

In an aspect, the processor 410 may be configured to execute computer executable instructions 460 stored at a non-transitory computer-readable medium, such as the memory 432, that are executable to cause a computer, such as the processor 410, to perform at least a portion of any of the methods described herein.

A camera interface 468 is coupled to the processor 410 and is also coupled to a camera, such as a video camera 470. A display controller 426 is coupled to the processor 410 and to a display device 428. A coder/decoder (CODEC) 434 can also be coupled to the processor 410. A speaker 436 and a microphone 438 can be coupled to the CODEC 434. A wireless interface 440 can be coupled to the processor 410 and to an antenna 442 such that wireless data received via the antenna 442 and the wireless interface 440 can be provided to the processor 410. In a particular aspect, the processor 410, the display controller 426, the memory 432, the CODEC 434, the wireless interface 440, and the camera interface 468 are included in a system-in-package or system-on-chip device 422. In a particular aspect, an input device 430 and a power supply 444 are coupled to the system-on-chip device 422. Moreover, in a particular aspect, as illustrated in FIG. 4, the display device 428, the input device 430, the speaker 436, the microphone 438, the wireless antenna 442, the video camera 470, and the power supply 444 are external to the system-on-chip device 422. However, each of the display device 428, the input device 430, the speaker 436, the microphone 438, the wireless antenna 442, the video camera 470, and the power supply 444 can be coupled to a component of the system-on-chip device 422, such as an interface or a controller. As an example, the camera interface 468 may request camera data. The processor 410, which is coupled to the camera interface 468, may perform the blocks of FIG. 3 in response to the request for the camera data by the camera interface 468.

One or more of the disclosed aspects may be implemented in a system or an apparatus, such as the device 400, that may include a mobile phone, a cellular phone, a satellite phone, a computer, a set top box, an entertainment unit, a navigation device, a communications device, a personal digital assistant (PDA), a fixed location data unit, a mobile location data unit, a tablet, a server, a portable computer, a desktop computer, a monitor, a computer monitor, a television, a tuner, a radio, a satellite radio, a music player, a digital music player, a portable music player, a video player, a digital video player, a digital video disc (DVD) player, a portable digital video player, a wearable device, a headless device, or a combination thereof. As another illustrative, non-limiting example, the system or the apparatus may include remote units, such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof.

Although one or more of FIGS. 1-4 may illustrate systems, apparatuses, and/or methods according to the teachings of the disclosure, the disclosure is not limited to these illustrated systems, apparatuses, and/or methods. Aspects of the disclosure may be suitably employed in any device that includes integrated, circuitry including a processor and a memory.

Those of skill would further appreciate that the various illustrative logical blocks, configurations, modules, circuits, and algorithm steps described in connection with the aspects disclosed, herein may be implemented as electronic hardware, computer software executed by a processor, or a combination thereof. Various illustrative components, blocks, configurations, modules, circuits, and steps have been described, above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An illustrative storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the aspects set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any aspects of this disclosure. Neither is the “Summary” to be considered as a characterization of the aspects set forth in issued claims. Furthermore, any reference in this disclosure to “aspect” in the singular should not be used to argue that there is only a single point of novelty in this disclosure. Multiple aspects may be set forth according to the limitations of the multiple claims issuing from this disclosure, and such claims accordingly define the aspects, and their equivalents, that are protected thereby. In all instances, the scope of such claims shall be considered on their own merits in light of this disclosure, but should not be constrained by the headings herein.

What is claimed is:

1. A method for way mispredict mitigation on a way predicted set-associative cache, the method comprising:
searching the cache for data, the data being associated with a first cache line;
accessing, while searching the cache, a way prediction array, the way prediction array comprising entries associated with ways of the cache;
determining, from the way prediction array, based on a prediction technique, a predicted way to search for the data;
searching the predicted way to determine a hit or a miss for the data;
determining the miss in the predicted way for the data;
in response to determining the miss in the predicted way for the data:
determining a first prediction index associated with a second cache line comprised in the predicted way;
determining a second prediction index associated with a search address, the search address being used for accessing the cache during execution of an instruction;
determining whether the first prediction index matches the second prediction index; and
in response to determining the first prediction index matches the second prediction index, selecting the predicted way as a victim way.

2. The method of claim 1, further comprising writing the data associated with the first cache line to the victim way.

3. The method of claim 1, wherein the set-associative cache comprises a multiple way set-associative cache.

4. The method of claim 1, further comprising, reading the way prediction array for determining the predicted way to search for the data.

5. The method of claim 1, wherein the second prediction index is associated with the first cache line being searched for in the cache.

6. The method of claim 1, further comprising in response to determining the first prediction index matches the second prediction index, overriding a victim selection policy used for selecting the victim way.

7. The method of claim 1, further comprising in response to determining the first prediction index does not match the second prediction index, using a victim selection policy for selecting the victim way.

8. An apparatus for way mispredict mitigation on a way predicted set-associative cache, the apparatus comprising:
a memory storing instructions;
control logic comprising a way prediction array; and
a processor comprising the cache, coupled to the control logic and the memory, and configured to:
search the cache for data, the data being associated with a first cache line;
access, while searching the cache, a way prediction array, the way prediction array comprising entries associated with ways of the cache;
determine, from the way prediction array and based on a prediction technique, a predicted way to search for the data;
determine a miss in the predicted way for the data;
in response to determining the miss in the predicted way for the data:
determine a first prediction index associated with a second cache line comprised in the predicted way;
determine a second prediction index associated with a search address, the search address being used for accessing the cache during execution of the instruction;
determine whether the first prediction index matches the second prediction index; and
in response to determining the first prediction index matches the second prediction index, select the predicted way as a victim way.

9. The apparatus of claim 8, wherein the processor is further configured to write the data associated with the first cache line to the victim way.

10. The apparatus of claim 8, wherein the set-associative cache comprises a multiple way set-associative cache.

11. The apparatus of claim 8, wherein the processor is further configured to read the way prediction array for determining the predicted way to search for the data.

12. The apparatus of claim 8, wherein the second prediction index is associated with the first cache line being searched for in the cache.

13. The apparatus of claim 8, wherein the processor is further configured to in response to determining the first prediction index matches the second prediction index, override a victim selection policy used for selecting the victim way.

14. The apparatus of claim 8, wherein the processor is further configured to in response to determining the first prediction index does not match the second prediction index, use a victim selection policy for selecting the victim way.

15. An apparatus for way mispredict mitigation on a way predicted set-associative cache, the apparatus comprising:
means for searching the cache for data, the data being associated with a first cache line;
means for accessing, while searching the cache, a way prediction array, the way prediction array comprising entries associated with ways of the cache;
means for determining, from the way prediction array, based on a prediction technique, a predicted way to search for the data;
means for searching the predicted way to determine a hit or a miss for the data;
means for determining the miss in the predicted way for the data;
in response to determining the miss in the predicted way for the data:
means for determining a first prediction index associated with a second cache line comprised in the predicted way;
means for determining a second prediction index associated with a search address, the search address being used for accessing the cache during execution of an instruction;
means for determining whether the first prediction index matches the second prediction index; and
in response to determining the first prediction index matches the second prediction index, means for selecting the predicted way as a victim way.

16. The apparatus of claim 15, further comprising means for writing the data associated with the first cache line to the victim way.

17. The apparatus of claim 15, further comprising means for reading the way prediction array for determining the predicted way to search for the data.

18. The apparatus of claim 15, wherein the second prediction index is associated with the first cache line being searched for in the cache.

19. The apparatus of claim 15, further comprising in response to determining the first prediction index matches the second prediction index, means for overriding a victim selection policy used for selecting the victim way.

20. The apparatus of claim 15, further comprising in response to determining the first prediction index does not match the second prediction index, means for using a victim selection policy for selecting the victim way.
